(19) United States
(12) Patent Application Publication
(10) Pub. No.: US 2007/0152003 A1
(43) Pub. Date: Jul. 5, 2007

(54) Swingout portable beverage cooler caddy

(76) Inventor: Robert Lee Dollar JR., Dunnellon, FL (US)

Correspondence Address: Douglas Wm. Massinger, Esq.;Massinger Law Offices, 887 N.E. 100 Street, Ocala, FL, 34479, US

(21) Appl. No.: 11/325,590

(22) Filed: Jan. 4, 2006

(51) Int. Cl. B60R 9/00; B60R 11/00

(52) U.S. Cl. 224/404; 224/926; 224/553

(57) ABSTRACT

A swingout portable beverage cooler caddy for use in vehicles equipped with a cargo area is comprised of a carriage assembly capable of supporting the weight of a filled cooler, a pivotable stanchion to which the carriage assembly is attached, mounting means for securing the carriage assembly to the interior surface of the cargo area, and locking means for securing the carriage assembly in place during stowage of the cooler within the cargo area. The subject apparatus provides a means for easily rotating the cooler from a stowage position inside the cargo area to an easily accessible position at the edge of or outside the cargo area such as overtop a lowered tailgate. The subject apparatus further restricts movement of the cooler preventing it from tipping over during operation of the vehicle.

### FIELD OF THE INVENTION

The subject invention relates generally to an accessory device for vehicles having cargo storage beds and to a swingout portable beverage cooler caddy therefore, in particular.

### BACKGROUND OF THE INVENTION

Portable beverage coolers such as the heavy-duty 5-gallon type produced by Igloo® Products, Inc., are popular among owners of utility vehicles and pick-up trucks having a cargo area suitable for their storage and transport. The traditional construction of a cargo space or “bed” in a pickup truck includes an area defined by a floor panel, two upright sidewalls, an optional center wall (in pickup trucks) joining the two sidewalls, and a tailgate. The tailgate may be of the swingout type whereby it is hingedly attached to a sidewall and pivots along a vertical axis, or may be of the fold-down type whereby it is hingedly attached to the floor panel of the bed along a horizontal axis. In some vehicles such as SUV's and minivans, the tailgate/window combination is of the “hatchback” type being hingedly attached to the roof panel and swings upward to a horizontal, open position. The subject invention may be employed in all of the above described vehicles.

Heretofore, the storage and transportation of portable beverage coolers within the cargo area of pick-up trucks and the like has not been without complications. A common problem is that the manipulation of these containers within the cargo area can be difficult, particularly when the container is filled with liquid because its overall weight can exceed 40 pounds. For instance, in vehicles having a fold-down tailgate, the filled container must be moved using considerable force from the tailgate of the vehicle into the cargo area for storage and transport, and then moved once again back onto the tailgate during use (it is typically desirable to orient the spout of the container over the edge of the tailgate to accommodate the filling of cups). Movement of a heavy cooler into and out of a cargo area is particularly challenging in fold-down type tailgated vehicles because the lowered tailgate impedes access to the bed, and access to the cooler from either side of the vehicle is impeded by the side walls of the bed.

One invention which has posited a solution of the above problem is disclosed in U.S. Pat. No. 6,588,720 issued to Revette in July of 2003. Revette teaches a holder for a portable water cooler designed to be mounted onto the inside of the side of a bed of a pickup truck. The water cooler holder has a cylindrical container-like member which holds the water cooler therein which member is mounted onto a frame which pivots from a first downward position to a second upward position so that the water cooler can be accessed from the outside of the bed of the pickup. A significant shortcoming of the Revette device is that considerable force is required to lift the holder from its lowered stowage position to its raised operative position above the wall to which it is mounted. Given the weight of a filled cooler, such an undertaking would likely require the user to step into the cargo area itself to have sufficient leverage to lift the container. A Herculean effort would no doubt be required to lift the container to its upright operative position while standing outside the vehicle bed.

Another problem associated with the storage and transport of portable beverage coolers within vehicle cargo areas is the propensity of the container to shift when exposed to the forces of a moving vehicle. Such movement can be moderate, resulting in the mere nuisance of having the container shift towards the front of the vehicle and therefore out of reach, or more severe, resulting in the overturning of the container and spillage of its contents.

Several U.S. Patents have been issued for carriers intended to restrict the movement of articles within a vehicle's cargo area. For instance, U.S. Pat. No. 3,765,635, entitled Bracket For Gas Containers And Similar Tanks, discloses a support plate which may be bolted or screwed to a truck wall and a collar bolted to the support plate. The collar is made of two semicircular pieces, hinged together at one end. An upper flange of a tank may be placed within the collar and the pieces may be clamped together opposite the hinged ends, securing the tank.

Similarly, U.S. Pat. No. 4,860, entitled MOUNTING RACK, teaches a water jug carrier for truck beds. The device is comprised of an attachment plate with a bracket that is bolted to a wall of the bed and several removable components attached to the bracket for retaining the jug in place.

While not directed to an apparatus for holding coolers, U.S. Pat. No. 5,799,849 discloses a safety carrier for stabilizing a pressure-fluid bottle in an upright position in a vehicle's cargo area. The bottle retention ring of this device may be selectively changed by a user, without disconnecting from its mounting frame, between an operative configuration and a stowage configuration. In the operative configuration, the ring is generally horizontal and projects out over the pickup box's floor to receive the bottle. In the stowage configuration, the ring is rotated to a generally vertical position and the arm is pivoted to swing the ring flush against the wall of the bed.

Unfortunately, none of the aforementioned devices are intended to facilitate access to the cooler in addition to securing it in place.

It is clear that a significant need exists for a cooler retention device that is 1) usable in vehicles having a fold-down tailgate, 2) capable of securing the cooler in place during storage and transit, and 3) obviates the need to manually drag the cooler from the cargo area onto the tailgate and vice versa for use and storage of the cooler, respectively. None of the references described above, alone or in combination, teach a device having all of the above benefits and capabilities.

### SUMMARY OF THE INVENTION

The subject invention more specifically relates to a swingout portable beverage cooler caddy for use in vehicles equipped with a flatbed type cargo space, the caddy being comprised generally of a cooler carriage assembly fixedly attached to one end of a stanchion which in turn is pivotally mounted to the inside wall of a cargo bed. The carriage assembly includes a horizontal base oriented in parallel relationship to the floor of the vehicle's cargo area and adapted to receive thereon a portable beverage cooler.

When a beverage cooler is seated in the carriage of the subject portable beverage cooler caddy, the subject invention provides a means for pivotally transporting the cooler about a vertical axis of rotation from a stowage position within the cargo bed to a more accessible position outside the cargo area. The carriage further includes cooler retention means for securely holding the cooler in place within the cargo area during transport.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is, therefore, a primary object of the subject invention to provide a swingout portable beverage cooler caddy for use in vehicles equipped with a flatbed type cargo space.

It is also a primary object of the subject swingout portable beverage cooler caddy to provide a means for easily moving the mounted cooler from a position inside the cargo area to a more easily accessible position of the cargo area or outside the cargo area altogether.

Another primary object of the subject swingout portable beverage cooler caddy is to provide a means for restricting movement of the cooler within the cargo area during transport.

It is also an object of the subject invention to provide a swingout portable beverage cooler caddy that may be easily and quickly mounted to the interior wall of a vehicle's cargo area.

Yet another object of the present invention is to provide a swingout portable beverage cooler caddy which is relatively inexpensive to manufacture and thereby affordable to the average consumer of such products.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying drawings and descriptive matter in which there is illustrated a preferred embodiment of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the subject swingout portable beverage cooler caddy shown in its operative position above a vehicle's tailgate;

FIG. 2 is an enlarged view of the mounting and locking assemblies of the invention of FIG. 1; and

FIG. 3 is a diagram of the mounting assembly of the subject invention;

FIG. 4 is a plan view of the mounting and locking assemblies of the subject invention; and

FIG. 5 is a perspective view of the subject invention with a portable beverage cooler mounted thereon and situate over the planar surface of a tailgate, the invention being in its operative position.

### DETAILED DESCRIPTION OF THE PREFERRED EMBODIMENT

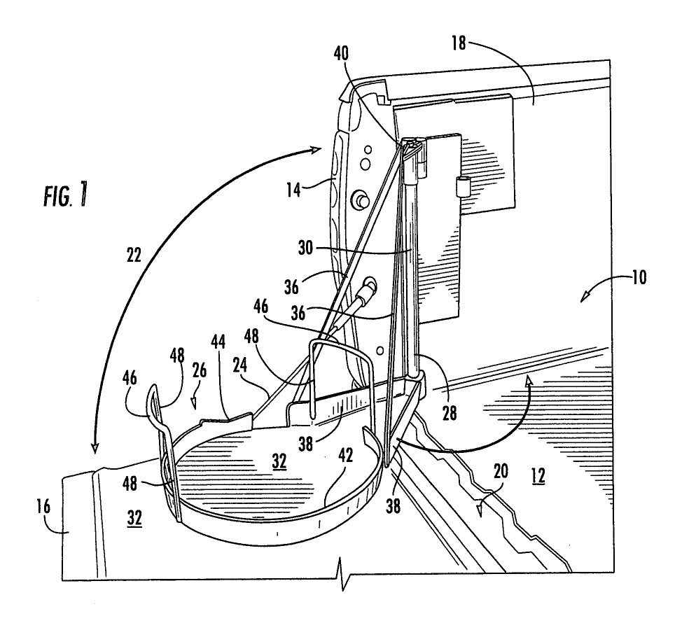

Reference is now made to FIG. 1 in which there is illustrated in cutaway view the cargo area of a conventional pickup truck, of the fold-down tailgate type, to which the subject swingout portable beverage cooler caddy may be mounted. It should be immediately understood that the subject invention may be employed in the cargo areas of other vehicle types as well such as those in utility vehicles and station wagons having swingout or lift-up rear doors, for instance.

Before the objects and advantages of the subject invention can be appreciated, it is helpful to understand the general construction of vehicle's cargo area. To this end, the vehicle's cargo area 10 is an open space defined by a bed or floor panel 12 situate in substantially horizontal orientation and having perpendicularly attached thereto two upright side walls 14 which are oriented in parallel relationship to one another along a vertical plane. A rear door 16 connects the two side walls towards the rear of the vehicle. The forward portion of the cargo area may either be either closed (such as in the case of pickup trucks) or open (such as in the case of station wagons or utility vehicles or “SUV's”).

In the example illustrated in FIG. 1, rear door 16 is of the fold-down tailgate type found in pickup trucks. An essentially rectangular tailgate 16 is connected at both ends to the interior panels 18 of sidewalls 14 by conventional hinges or other suitable coupling means. Attachment of tailgate 16 in this manner permits pivotal rotation about horizontal axis 20, as indicated by directional arrow 22, between open and closed positions. When closed (not shown), tailgate. 16 occupies a substantially vertical plane and lies perpendicular to floor panel 12. When open, tailgate 16 is situate in a substantially horizontal orientation substantially coplanar with floor panel 12 and essentially forming a rearward extension thereof. Tailgate restraining means 24 connected between each interior panel 18 and the sides of tailgate 16, limit opening of the tailgate to the horizontal plane. Restraining means 24 are typically of the flexible cable type or are comprised of articulated linkage. As stated above, the fold-down tailgate 16 may be substituted with a swingout or lift-up type rear door (not shown). These latter types of door configurations, when in the open position, allow easier access to the cargo area of the vehicle as opposed to a fold-down tailgate which actually blocks its access. Accordingly, the subject invention finds its greatest utility in the latter type configuration as will soon be made apparent.

With continued reference to FIG. 1, the subject invention more specifically relates to a swingout portable beverage cooler caddy for use in vehicles equipped with a cargo area 10 and is comprised generally of a cooler carriage assembly 26 fixedly attached to a first end 28 of a pivotable stanchion 30 which in turn is mounted to an interior wall 18 of the cargo bed via mounting means as described in detail below. Carriage assembly 26 includes a base 32 which is preferably, but not essentially, teardrop in shape and occupies a substantially horizontal plane with its vertex 34 serving as the attachment point to stanchion 30. In order to enable base 32 to support the load of a filled beverage cooler, weight support means are provided in the form of a pair of diagonal support members 36 which connect each side 38 of base 32 to second end 40 of stanchion 30. Thusly configured, base 32 of carriage assembly 26 is substantially suspended from stanchion 30 in suspension bridge-like fashion. A retention wall 42 extends a distance vertically from base 32 and around its perimeter to add structural integrity to the carriage assembly generally. Retention wall 42 further provides a means for retaining the base of a beverage cooler in place when seated in carriage assembly 26 (see FIG. 5). Note that a portion of retention wall 42 may optionally include a detent 44 which is shaped to conform to a corresponding concave region of the Igloo® brand 5 gallon beverage cooler. Additional cooler retention means are preferably included in carriage assembly 26 and may be comprised of, for instance, side rails 46 which serve to cradle the cooler in place when mounted on base 32. Side rails 46 are curved to conform to the circumference of a standard 5 gallon beverage cooler and are supported by uprights 48. It should be appreciated that cooler retention means is preferably comprised of at least two opposing side rails 46 as shown, or may be constructed of a complete ring within which the cooler is seated. In either event, cooler retention means are adapted in height to prevent the cooler from tipping over while the vehicle is in operation.

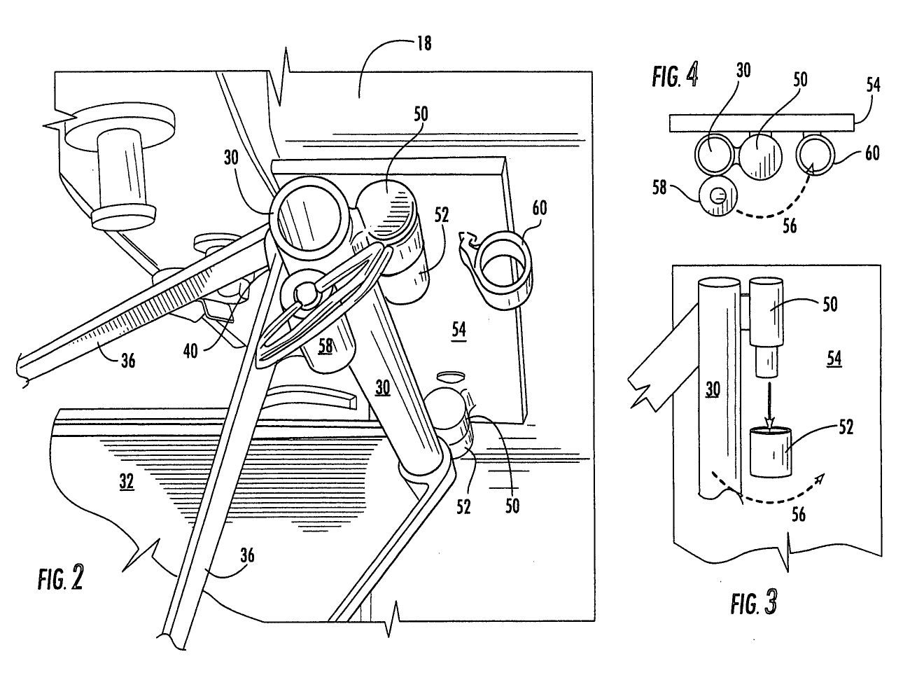

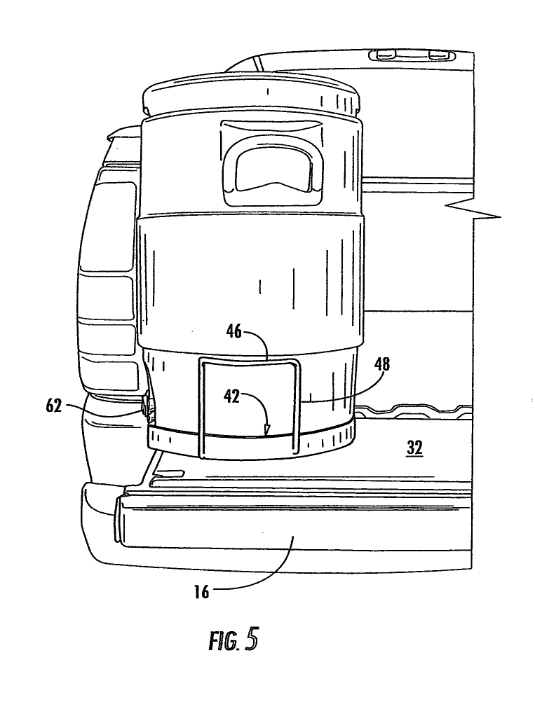

As previously described, carriage assembly 26 is fixedly attached to a pivotable stanchion 30. Referring now to FIG. 2, the mounting and locking assemblies of the subject invention may be observed. The mounting assembly is comprised of at least two mounting pins 50 which are fixedly attached to opposite ends of stanchion 30, each mounting pin 50 being received within corresponding receivers 52 (FIG. 3) to form hinges about which stanchion 30 is capable of pivotable rotation along arced pathway 56 (see FIG. 4). Each receiver 52 is in turn fixedly attached to mounting plate 54 which is mounted via conventional means to the interior surface 18 of the vehicle's side wall 14. More specifically, mounting plate 54 should be positioned such that pivotable stanchion 30 is adjacent to, and in parallel relationship with, tailgate 16 when in its closed position. It should be further appreciated that the entire carriage assembly 26 and attached stanchion 30 may be removed from the vehicle by simply lifting the unit vertically out of receivers 52 leaving the cargo area virtually empty.

With continued reference to FIG. 2 and additional reference to FIG. 4, the locking assembly of the subject invention may be observed, and is comprised of a conventional spring loaded locking pin 58 and corresponding locking ring 60. As may be appreciated, carriage assembly 26 may be rotated around the vertical axis of mounting pins 50 until side wall 38 lies parallel with side wall 14. Thusly positioned, locking pin 58 will be axially aligned with, and inserted into, locking ring 60 thereby preventing movement of carriage assembly 26. This position is employed when stowing the cooler in the cargo area 10 of the vehicle.

When access to the cooler is desired, locking pin 58 is disengaged from locking ring 60 and the user causes carriage assembly to rotate outward to the desired position. In vehicles equipped with a fold-down tailgate, carriage assembly is preferably rotated until the spout 62 of the cooler extends beyond the edge of tailgate 16 when in its horizontal, lowered position (see FIG. 5). This position facilitates the filling of cups or other containers which may be positioned immediately below the spout, unimpeded by tailgate 16. In vehicles equipped with a swingout or lift-up rear door, carriage assembly 26 is preferably rotated to an intermediate position (not shown) such that spout 62 extends slightly beyond the rear edge of cargo area 10, above the bumper of the vehicle. In either case, the user is no longer required to lift or drag the heavy cooler from the cargo area or be concerned with the cooler tipping over during operation of the vehicle. Additional securing means may also be employed such as straps or the like to prevent cooler movement altogether.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications, but rather only by the scope of the claims appended hereto.

What is claimed as being new, useful and desired to be protected by Letters Patent of the United States is as follows:

1. A swingout portable beverage cooler caddy for use in vehicles equipped with a flatbed cargo space comprising a floor panel, two upright sidewalls and a tailgate, the caddy comprising, 1) a stanchion pivotally mounted to the interior surface of a sidewall, said stanchion being oriented perpendicular to the floor panel and proximate to the tailgate, and 2) a cooler carriage assembly fixedly attached to said stanchion, said cooler carriage assembly being oriented above the floor panel in non-contacting relationship, whereby a cooler may be mounted on said cooler carriage assembly which in turn may be rotated from a stowage position within the cargo space to a more accessible position outside the cargo space.

2. A swingout portable beverage cooler caddy for use in vehicles equipped with a flatbed cargo space comprising a floor panel, two upright sidewalls and a tailgate, the caddy comprising, 1) a stanchion pivotally mounted to the interior surface of a sidewall, said stanchion being oriented perpendicular to the floor panel and proximate to the tailgate, 2) a cooler carriage assembly fixedly attached to said stanchion, said cooler carriage assembly comprising, a) a base oriented parallel to and above the floor panel in non-contacting relationship, and b) at least one diagonal support member fixedly attached between said base and said stanchion, whereby a cooler may be mounted on said base of said cooler carriage assembly which in turn may be rotated from a stowage position within the cargo space to a more accessible position outside the cargo space.

3. A swingout portable beverage cooler caddy for use in vehicles equipped with a flatbed cargo space comprising a floor panel, two upright sidewalls and a tailgate, the caddy comprising, 1) a stanchion pivotally mounted to the interior surface of a sidewall, said stanchion being oriented perpendicular to the floor panel and proximate to the tailgate, 2) a cooler carriage assembly fixedly attached to said stanchion, said cooler carriage assembly being oriented above the floor panel in non-contacting relationship, and 3) cooler retention means fixedly attached to said carriage assembly for securely mounting a cooler thereon, whereby a cooler may be mounted on said cooler carriage assembly which in turn may be rotated from a stowage position within the cargo space to a more accessible position outside the cargo space.
